(19) United States
(12) Patent Application Publication
(10) Pub. No.: US 2013/0149423 A1
(43) Pub. Date: Jun. 13, 2013

(54) WHISKEY MAKING METHOD

(71) Applicant: Thomas Steven Lix, Parma, OH (US)

(72) Inventor: Thomas Steven Lix, Parma, OH (US)

(73) Assignee: Cleveland Whiskey LLC, Cleveland, OH (US)

(21) Appl. No.: 13/592,317

(22) Filed: Aug. 22, 2012

Related U.S. Application Data
(63) Continuation-in-part of application No. PCT/US2010/048259, filed on Sep. 9, 2010.
(60) Provisional application No. 61/247,539, filed on Sep. 30, 2009.

(51) Int. Cl. C12H 1/22; B65D 85/72

(52) U.S. Cl. 426/397; 426/665

(57) ABSTRACT

A whiskey making method is provided wherein container pressure is controllably varied to mimic, at an increased frequency, the mimic those which occur during cycles of a conventional aging process. To make a whiskey having taste qualities similar to one aged for a conventional aging period (e.g., usually thirty-six months or more), the pressure-varying steps need only be repeated for a period of less than nine months.

### RELATED APPLICATIONS

This application claims priority under 35 USC §120 to PCT Patent Application Number U.S./2010/048259 filed Sep. 9, 2010 which claimed priority to U.S. Provisional Patent Application No. 61/247,539 filed on Sep. 30, 2009. The entire disclosure this international application and the entire disclosure of this provisional application are hereby incorporated by reference.

### BACKGROUND

After high proof whiskey is distilled, it is stored in a wood container (e.g., an oak barrel). During this storage, the wood adds color and flavor to the whiskey. After a sufficient aging period, typically 2 to 6 years (and sometimes more than 10 years), the high proof solution is drained from the container and bottled for commercial sale.

### SUMMARY

A whiskey-making method is provided wherein the aging period is fast-forwarded by mimicking, at an increased frequency, the changes experienced by the distillate during a conventional aging period. With this method, the time to market is dramatically decreased, and long-term storage needs are reduced. Additionally or alternatively, repeatable aging parameters are possible and the effects of year-to-year climate changes are minimized.

### DRAWINGS

FIG. 1 is a schematic diagram of the whiskey-making method of the present invention wherein the temperature is controllably changed and/or the pressure is controllably varied.

FIG. 2 is a graph showing pressure conditions during a conventional aging period (dashed line) and the controlled pressure variances that occur with the whiskey-making method (solid line) of the present invention.

### DESCRIPTION

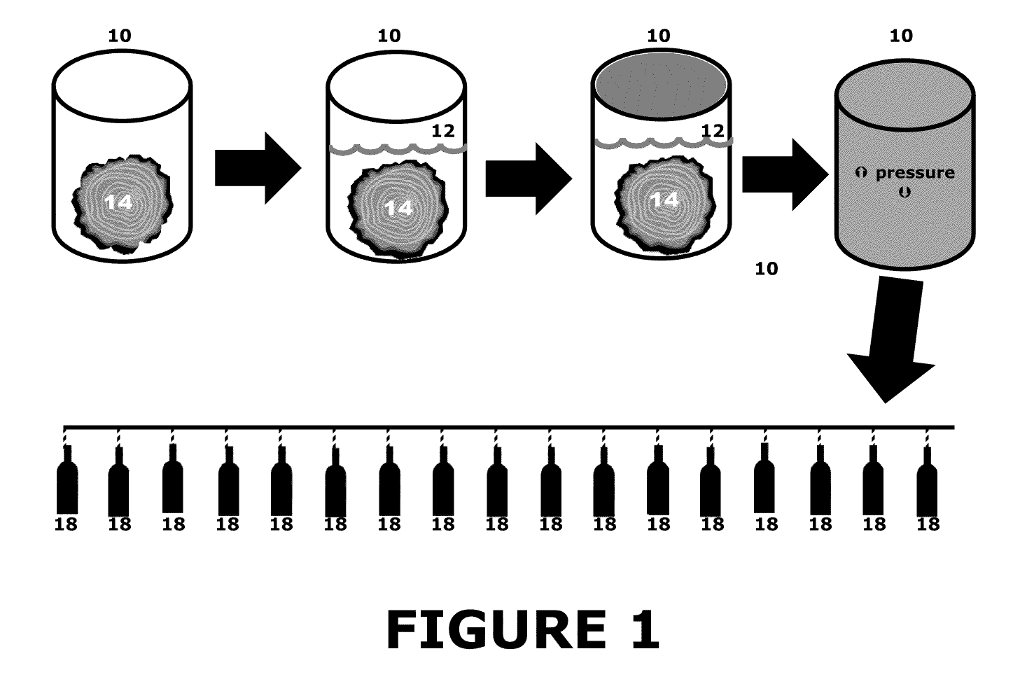

Referring now to the drawings, and initially to FIG. 1, a process for producing an alcoholic beverage for human consumption is schematically shown. This alcoholic beverage can comprise whiskey, which traditionally has required a prolonged aging period. Scotch whisky, for example, typically takes an average of 12 or more years to mature. Bourbon and other “American Whiskeys” (e.g., rye, wheat, and barley) typically take 6 to 9 years.

The whiskey-producing process comprises container 10 and distillate 12 placed within the container 10 so that it is contact with a wood (e.g., oak) surface area 14. The container can be sealed and pressure therewithin can be controllably varied. After completion of the pressure-varying steps, the high proof solution can be drained from the container 10 into bottles 18 for commercial sale.

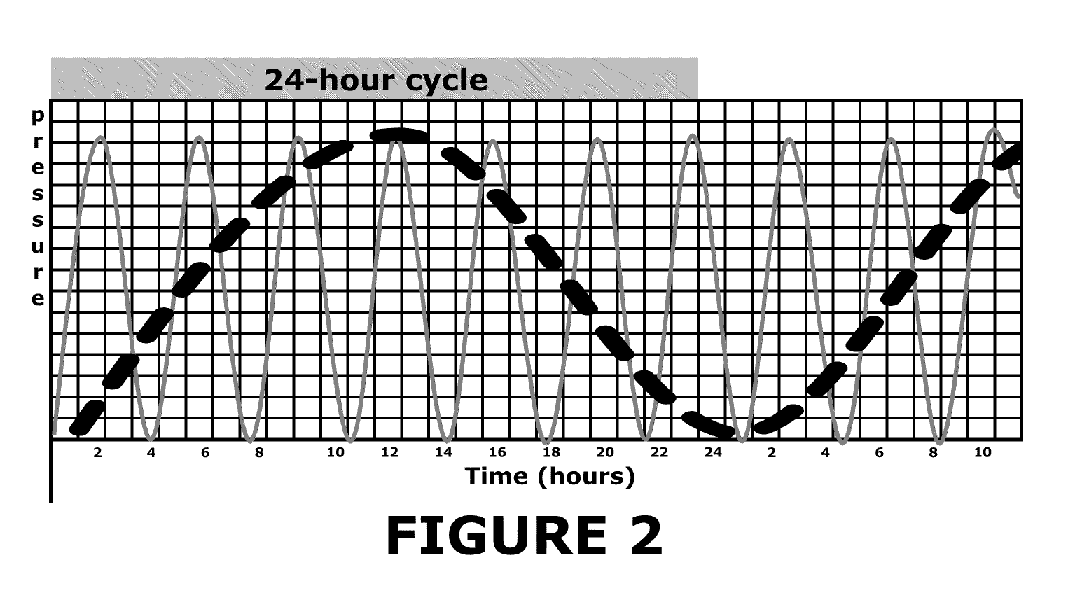

As is shown in FIG. 2 (by the dashed line), in a conventional aging process, the pressure varies during each 24-hour cycle. These 24-hour cycles, are repeated throughout the duration of the conventional aging period which, as indicated above, is usually longer than 3 years. As is also shown in FIG. 2 (by the solid line), with the present method, the pressure can be varied to mimic the changes that occur during each 24-hour cycle of the aging period at an increased frequency.

Pressure changes within the container 10 can cause the pores of the wood surface area 14 to open and close. The wood pores s collectively act as a multitude of tiny pumps drawing distillate inward when they expand and discharging it outward when they contract. With the present method, the frequent opening and closing of the wood pores is believed to speed and/or enhance the color and flavor of the distillate.

Pressure variances between −2 ATM and +10 ATM can be employed, with the variance being at least 1 ATM, at least 2 ATM, at least 3 ATM, at least 4 ATM, at least 5 ATM between the maximum pressure and the minimum pressure. The increased frequency of the pressure-varying steps can be at least 3, at least 4, at least 5, at least 6, at least 7, at least 8, at least 9, at least 10, at least 12 times, at least 14 times, at least 16 times, at least 18 times, at least 20 times, at least 22 times, and/or at least 24 times that of the conventional aging cycle or 24 hours. And these steps can be repeated for a period much shorter than that of a conventional aging period (e.g., less than nine months, less than six months, less than three months, less than two months, and/or less than one month).

Pressure-varying steps can be accomplished by controllably changing the temperature within the container 10 (e.g., by heating and/or cooling steps). The temperature can be controllably adjusted between 0° F. and 200° F., with the temperature changing at least 5° F., at least 10° F., at least 15° F., at least 20° F., at least 25° F., at least 30° F. and/or at least 35° F. ° C. between the maximum temperature and the minimum temperature. Alternatively, pressure-varying steps can be accomplished by controllably changing the volume of the container 10.

As was indicated above, the distillate 12 is in contact with a wood (e.g., oak) surface area 14 within the container 10. To this end, the container 10 can be at least partially made of wood (e.g., an oak barrel) as shown in FIG. 4. In this case, the wood surface area 14 is an interior surface of the container 10.

The container 10 may instead be a non-wood and/or non-porous material, such as metal (e.g., steel), ceramic, glass, or plastic drums, like the container 10. The wood surface area 14 can be in the form of wood inserts appropriately arranged within the container 10. This may allows an increased in wood contact (and thus pores) when compared to conventional barrel constructions.

Although the whiskey-making method has been shown and described with respect to some possible embodiments, it is obvious that equivalent alterations and modifications will occur to others skilled in the art upon the reading and understanding of this specification and the annexed drawings.

1. A method for making an alcoholic beverage for human consumption having taste qualities similar to one aged for a conventional aging period, said method comprising the steps of:
placing distillate into a container whereat it is in contact with a wood surface area; and
controllably varying the pressure within the container during a 24 hour cycle so that the pressure varies at least 1 ATM between a maximum pressure and a minimum pressure; and
repeating said pressure-varying steps for a period less than nine months.

2. A method as set forth in claim 1, wherein said pressure-varying steps are repeated for a period less than six months.

3. A method as set forth in claim 2, wherein said pressure-varying steps are repeated for a period less than three months.

4. A method as set forth in claim 3, wherein said pressure-varying steps are repeated for a period less than two months.

5. A method as set forth in claim 4, wherein said pressure-varying steps are repeated for a period less than one month.

6. A method as set forth in claim 1, wherein the pressure varies at least 2 ATM between a maximum pressure and a minimum pressure.

7. A method as set forth in claim 6, wherein the pressure varies at least 3 ATM between a maximum pressure and a minimum pressure.

8. A method as set forth in claim 7, wherein the pressure varies at least 4 ATM between a maximum pressure and a minimum pressure.

9. A method as set forth in claim 8, wherein the pressure varies at least 5 ATM between a maximum pressure and a minimum pressure.

10. A method as set forth in claim 1, wherein the maximum pressure is +10 ATM or less.

11. A method as set forth in claim 1, wherein the minimum pressure is −2 ATM or more.

12. A method as set forth in claim 1, wherein the pressure-varying steps are accomplished by controllably changing the temperature within the container.

13. A method as set forth in claim 1, wherein the pressure-varying steps are accomplished by controllably changing the volume within the container.

14. A method as set forth in claim 1, further comprising the step of bowing the solution in the container after completion of the pressure-varying steps.

15. A method as set forth in claim 1, wherein the alcoholic beverage is whiskey.

16. A method as set forth in claim 15, wherein said pressure-varying steps are repeated for a period less than three months.

17. A method as set forth in claim 16, wherein said pressure-varying steps are repeated for a period less than two months.

18. A method as set forth in claim 17, wherein said pressure-varying steps are repeated for a period less than one month.

19. A method as set forth in claim 15, wherein the maximum pressure is +10 ATM or less and wherein the minimum pressure is −2 ATM or more.

20. A method as set forth in claim 15, further comprising the step of bowing the solution in the container after completion of the pressure-varying steps.
